(19) United States
(12) Patent Application Publication
(10) Pub. No.: US 2025/0077037 A1
(43) Pub. Date: Mar. 6, 2025

(54) IMAGE PRESENTING METHOD AND DISPLAY DEVICE

(71) Applicant: Acer Incorporated, New Taipei City (TW)

(72) Inventors: Chi-Kang Lee, New Taipei City (TW); Chao-Kuang Yang, New Taipei City (TW); Shih-Hao Lin, New Taipei City (TW); Wen-Cheng Hsu, New Taipei City (TW); Hsi Lin, New Taipei City (TW)

(73) Assignee: Acer Incorporated, New Taipei City (TW)

(21) Appl. No.: 18/473,290

(22) Filed: Sep. 25, 2023

(30) Foreign Application Priority Data
Sep. 1, 2023 (TW) 112133266

(51) Int. Cl. G06F 3/0481; G06F 1/16; G06F 3/04845; G06F 9/451

(52) U.S. Cl. CPC G06F 3/0481; G06F 1/1641; G06F 3/04845; G06F 9/451; G06F 2203/04803

(57) ABSTRACT

An image presenting method and a display device are disclosed. The method includes: defining one vision region in a display interface of a foldable display via a first application programming interface; detecting a physical status of the foldable display; dividing the vision region into a first sub-vision region and a second sub-vision region in response to that the physical status of the foldable display is a folded status; and presenting a first desktop image and a second desktop image in the first sub-vision region and the second sub-vision region respectively via a second application programming interface, wherein one of the first desktop image and the second desktop image includes a toolbar image, and a presenting position of the toolbar image in the first sub-vision region or the second sub-vision region is variable.

### CROSS-REFERENCE TO RELATED APPLICATION

This application claims the priority benefit of Taiwan application serial no. 112133266, filed on Sep. 1, 2023. The entirety of the above-mentioned patent application is hereby incorporated by reference herein and made a part of this specification.

### BACKGROUND OF THE INVENTION

### Field of the Invention

The invention relates to an image display technique, and in particular, to an image presenting method and a display device.

### Description of Related Art

With the advancement of technology, display devices having foldable displays (such as smartphones or notebook computers) have appeared on the market. However, under the common Microsoft Windows operating system (OS) or Apple's iOS architecture, regardless of the type of display, the layout and presentation of the desktop image are fixed and may not be customized for the folded nature of the display. Therefore, in some cases, it may cause trouble to users when operating the foldable display.

### SUMMARY OF THE INVENTION

The invention provides an image presenting method and a display device that may improve a user's operating experience on a foldable display.

An embodiment of the invention provides an image presenting method configured for a display device. The display device includes a foldable display. The image presenting method includes: defining one vision region in a display interface of the foldable display via a first application programming interface; detecting a physical status of the foldable display; dividing the vision region into a first sub-vision region and a second sub-vision region in response to that the physical status of the foldable display is a folded status; and presenting a first desktop image and a second desktop image in the first sub-vision region and the second sub-vision region respectively via a second application programming interface, wherein one of the first desktop image and the second desktop image includes a toolbar image, and a presenting position of the toolbar image in the first sub-vision region or the second sub-vision region is variable.

An embodiment of the invention further provides a display device including a foldable display and a processor. The processor is coupled to the foldable display. The processor is configured to: define one vision region in a display interface of the foldable display via a first application programming interface; detect a physical status of the foldable display; divide the vision region into a first sub-vision region and a second sub-vision region in response to that the physical status of the foldable display is a folded status; and present a first desktop image and a second desktop image in the first sub-vision region and the second sub-vision region respectively via a second application programming interface, wherein one of the first desktop image and the second desktop image includes a toolbar image, and a presenting position of the toolbar image in the first sub-vision region or the second sub-vision region is variable.

Based on the above, one vision region may be defined in the display interface of the foldable display via the first application programming interface. After detecting that the physical status of the foldable display is in the folded status, the vision region may be divided into the first sub-vision region and the second sub-vision region. Then, the first desktop image and the second desktop image may be presented in the first sub-vision region and the second sub-vision region respectively via the second application programming interface. In particular, one of the first desktop image and the second desktop image may include the toolbar image, and the presenting position of the toolbar image in the first sub-vision region or the second sub-vision region is variable. Therefore, compared with the traditional layout and presenting method of desktop images presented by displays, which are fixed, the image presenting method and the display device proposed by the invention may effectively improve the user's operating experience for foldable displays.

### BRIEF DESCRIPTION OF THE DRAWINGS

FIG. 1 is a functional block diagram of a display device shown according to an embodiment of the invention.

FIG. 2A is a schematic diagram of a physical status of a foldable display in an unfolded status shown according to an embodiment of the invention.

FIG. 2B and FIG. 2C are schematic diagrams of a physical status of a foldable display in a folded status shown according to an embodiment of the invention.

FIG. 3A is a schematic diagram of an original desktop image and a toolbar image shown according to an embodiment of the invention.

FIG. 3B to FIG. 3D are schematic diagrams of a first desktop image, a second desktop image, and a toolbar image shown according to an embodiment of the invention.

FIG. 4A is a schematic diagram of presenting an application image in an original vision region shown according to an embodiment of the invention.

FIG. 4B is a schematic diagram of presenting an application image in a sub-vision region shown according to an embodiment of the invention.

FIG. 5 is a flowchart of an image presenting method shown according to an embodiment of the invention.

### DESCRIPTION OF THE EMBODIMENTS

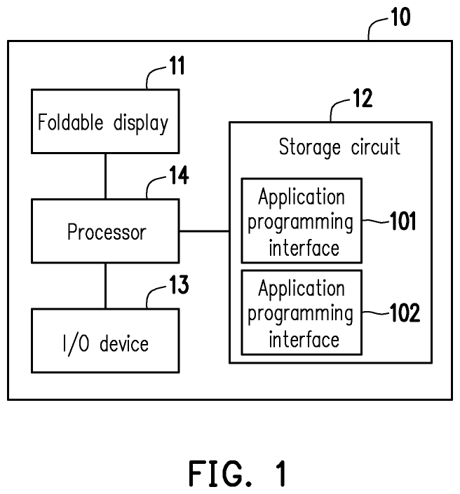

FIG. 1 is a functional block diagram of a display device shown according to an embodiment of the invention. Referring to FIG. 1, a display device 10 may include various electronic devices having display functions, such as smartphones, tablet computers, notebook computers, e-readers, or game consoles.

The display device 10 may include a foldable display 11, a storage circuit 12, an input/output (IO) device 13, and a processor 14. The foldable display 11 is configured to display an image and has a folding function. For example, the foldable display 11 may include a display such as plasma display, liquid-crystal display (LCD), thin-film transistor (TFT) liquid-crystal display, light-emitting diode (LED) display, or organic light-emitting diode (organic LED, OLED) display. It should be noted that the display type of the foldable display 11 is not limited thereto.

The storage circuit 12 is configured to store data. For example, the storage circuit 12 may include a volatile storage circuit and a non-volatile storage circuit. The volatile storage circuit is configured to store data in a volatile manner. For example, the volatile storage circuit may include random-access memory (RAM) or similar volatile storage media. The non-volatile storage circuit is configured to store data in a non-volatile manner. For example, the non-volatile storage circuit may include a read-only memory (ROM), a solid-state disk (SSD), a traditional hard disk drive (HDD), or similar non-volatile storage media. It should be noted that the type of storage circuit 12 is not limited thereto.

The input/output device 13 is configured to receive an input signal or send an output signal. For example, the input/output device 13 may include a physical keyboard, a touch panel, a mouse, a network interface card, and/or a speaker. It should be noted that the type of the input/output device 13 is not limited thereto.

The processor 14 is coupled to the foldable display 11, the storage circuit 12, and the input/output device 13. The processor 14 may be responsible for all or part of the operation of the display device 10. For example, the processor 14 may be a central processing unit (CPU), a graphics processing unit (GPU), or other programmable general-purpose or special-purpose microprocessors, digital signal processors (DSPs), programmable controllers, application-specific integrated circuits (ASICs), programmable logic devices (PLD), or other similar devices, or a combination of these devices.

In an embodiment, application programming interfaces (APIs) 101 and 102 are stored in the storage circuit 12. In an embodiment, the API 101 is also called a first API, and/or the API 102 is also called a second API. The processor 14 may control the foldable display 11 via the APIs 101 and 102.

In an embodiment, the API 101 is configured to define one or a plurality of vision regions in the display interface of the foldable display 11. Each vision region may cover a part of the display region in the display interface of the foldable display 11. In addition, the resolution of each vision region may be expressed as N pixels×M pixels. For example, the API 101 may include an OpenXR API, but the type of the API 101 is not limited thereto.

In an embodiment, the API 102 is configured to control images to be presented in the vision region. For example, the API 102 may include Intel Display Pipes MPO API, and the type of the API 102 is not limited thereto.

In an embodiment, the processor 14 may detect the physical status of the foldable display 11. For example, the physical status of the foldable display 11 may include a folded status and an unfolded status (also called a flat status). For example, when the foldable display 11 is folded, the physical status of the foldable display 11 is the folded status. Moreover, when the foldable display 11 is not folded, the physical status of the foldable display 11 is the unfolded status.

In an embodiment, in response to the physical status of the foldable display 11 being the unfolded status, the processor 14 may define one vision region (also referred to as the original vision region) in the display interface of the foldable display 11 via the application programming interface 101. For example, the original vision region may cover the entire display region of the display interface of the foldable display 11. Then, the processor 14 may present the desktop image (also referred to as the original desktop image) in the original vision region via the API 102.

In an embodiment, in response to the physical status of the foldable display 11 being the folded status, the processor 14 may divide the original vision region into a plurality of vision regions (also referred to as sub-vision regions) via the API 101. For example, the sub-vision regions may include a first sub-vision region and a second sub-vision region. For example, the first sub-vision region and the second sub-vision region may respectively cover part of the display region of the display interface of the foldable display 11, and the first sub-vision region and the second sub-vision region are not overlapped with each other. In addition, the resolution of the first sub-vision region may be greater than, less than, or equal to the resolution of the second sub-vision region. Then, the processor 14 may present a plurality of desktop images in these sub-vision regions respectively via the API 102. In an embodiment, the desktop image presented in the first sub-vision region is also called the first desktop image, and/or the desktop image presented in the second sub-vision region is also called the second desktop image.

In an embodiment, assuming that the resolution of the display interface of the foldable display 11 is 2560×1920, the resolution of the original vision region may be 2560×1920, the resolution of the first sub-vision region may be 2560×1440, and the resolution of the second sub-vision region may be 2560×480. It should be noted that the resolution of the original vision region and each sub-vision region may be adjusted according to practical needs, and is not limited by the invention. In an embodiment, the number of the original vision region and the sub-vision regions may also be adjusted according to practical needs, and is not limited by the invention.

In an embodiment, one of the first desktop image and the second desktop image includes a toolbar image. In particular, the presenting position of the toolbar image in the first sub-vision region or the second sub-vision region is variable. For example, at a certain point in time (also called the first point in time), the toolbar image may be presented at a certain position (also called the first position) in the first sub-vision region. At another point in time (also called the second point in time), the toolbar image may be presented at a certain position (also called the second position) in the second sub-vision region. In addition, both the first position and the second position may be dynamically determined or adjusted by the user.

In an embodiment, the processor 14 may obtain toolbar configuration information. For example, the processor 14 may read the toolbar configuration information from the storage circuit 12. This toolbar configuration information may contain information (such as coordinate information) of the presenting position of the toolbar image in the first sub-vision region and/or the second sub-vision region. In response to the physical status of the foldable display 11 being the folded status, the processor 14 may present the toolbar image in the first sub-vision region or the second sub-vision region according to the toolbar configuration information. In an embodiment, the toolbar image may also be presented in the first sub-vision region and the second sub-vision region at the same time.

In an embodiment, the processor 14 may receive a user operation via the input/output interface 13. The processor 14 may update the toolbar configuration information according to this user operation to adjust the presenting position of the toolbar image in the first sub-vision region and/or the second sub-vision region. For example, it is assumed that the original toolbar configuration information defines that the toolbar image is presented at the first position in the first sub-vision region. After the toolbar configuration information is updated according to the user operation, the updated toolbar configuration information may adjust the first position or change the toolbar image to the second position in the second sub-vision region.

In an embodiment, the toolbar configuration information may also include information on the presenting position of the toolbar image in the original vision region (such as coordinate information). In response to the physical status of the foldable display 11 being the unfolded status, the processor 14 may present the toolbar image in the original vision region according to the toolbar configuration information.

In an embodiment, the processor 14 may present at least one button (also referred to as a virtual button) in the toolbar image. Each virtual button is configured to launch one application (also called a target application). In an embodiment, the toolbar configuration information may also include configuration information of the virtual buttons. The processor 14 may present the virtual buttons in the toolbar image according to the toolbar configuration information. In an embodiment, the processor 14 may also update the toolbar configuration information according to the user operation to adjust the configuration information of the virtual buttons, such as changing the total number, type, and/or sorting of the virtual buttons presented in the toolbar image.

Traditionally, due to operating system specifications, when the foldable display 11 is in the folded status, the toolbar image may only be displayed in a fixed position, which is inconvenient in use. In an embodiment, by running the APIs 101 and 102, the processor 14 may define one or a plurality of vision regions (such as the original vision region and a plurality of sub-vision regions) in the display interface of the foldable display 11 and customize the images presented in the vision regions, thereby improving system operational flexibility. Moreover, via the dynamically updateable toolbar configuration information, the processor 14 may control the toolbar image to be presented at any position in any vision region according to the user's needs, thereby effectively improving the user experience.

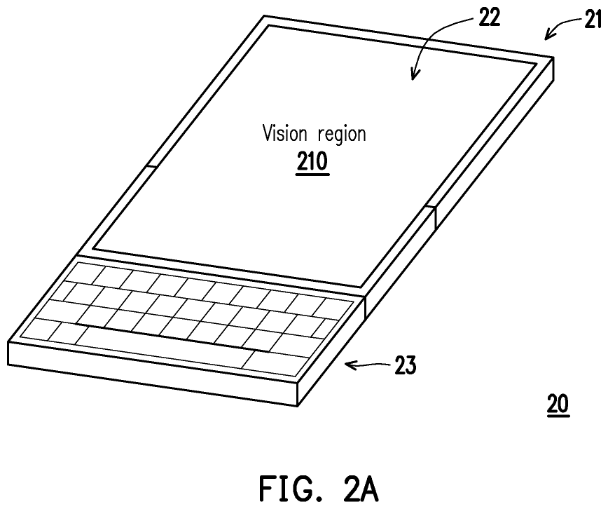

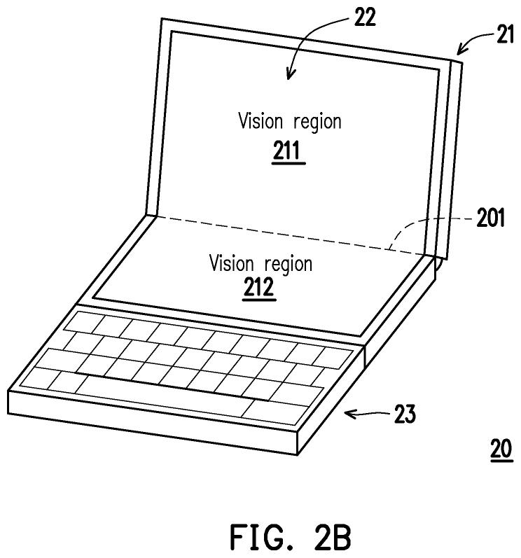

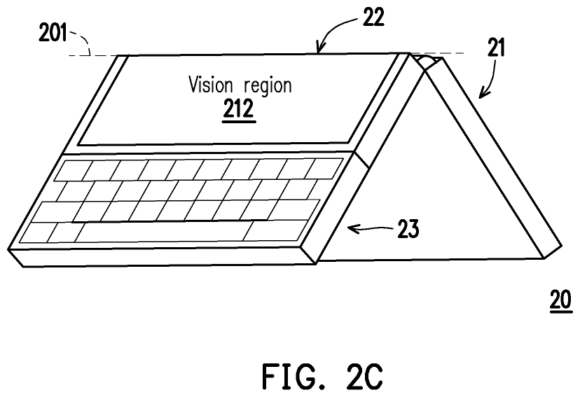

FIG. 2A is a schematic diagram of a physical status of a foldable display in an unfolded status shown according to an embodiment of the invention. Referring to FIG. 1 and FIG. 2A, it is assumed that the display device 10 includes a display device 20 and the foldable display 11 includes a foldable display 21. The foldable display 21 may present an image via the display interface 22. In an embodiment, the display device 20 may further include a physical keyboard 23. For example, the physical keyboard 23 may belong to the input/output device 13 of FIG. 1. Alternatively, in an embodiment, the display device 20 may not have the physical keyboard 23.

In an embodiment, in response to the physical status of the foldable display 21 being the unfolded status (as shown in FIG. 2A), the processor 14 may define one vision region 210 (i.e., the original vision region) in the display interface 22 of the foldable display 21 via the application programming interface 101. For example, the vision region 210 may cover the entire display region of the display interface 22.

FIG. 2B and FIG. 2C are schematic diagrams of a physical status of a foldable display in a folded status shown according to an embodiment of the invention. Please refer to FIG. 1, FIG. 2B, and FIG. 2C. In an embodiment, in response to the physical status of the foldable display 21 being the folded status, the processor 14 may define the vision regions 211 and 212 in the display interface 22 of the foldable display 21 via the application programming interface 101. It should be noted that one of the vision regions 211 and 212 may be a first sub-vision region, and the other one of the vision regions 211 and 212 may be a second sub-vision region.

In an embodiment, the vision regions 211 and 212 are distinguished by a virtual boundary line 201 in the display interface 22. For example, when the physical status of the foldable display 21 is the folded status, the display region located at a side of the virtual boundary line 201 in the display interface 22 may be defined as the vision region 211, and the display region located at another side of the virtual boundary line 201 in the display interface 22 may be defined as the vision region 212. In addition, the virtual boundary line 201 may be located at a folded position in the foldable display 21 (as shown in FIG. 2B and FIG. 2C).

In an embodiment, when the physical status of the foldable display 21 is the folded status, the foldable display 21 may be in an inward folded status (as shown in FIG. 2B) or an outward folded status (as shown in FIG. 2C). In an embodiment, the foldable display 21 may support two folded statuses: inward folded and outward folded. Alternatively, in an embodiment, the foldable display 21 may also only support one of the folded statuses of inward folded and outward folded, which is not limited by the invention.

In an embodiment, when the foldable display 21 is in the inward folded status (as shown in FIG. 2B), the image presenting direction of the image in the vision region 211 is the same as the image presenting direction of the image in the vision region 212. However, when the foldable display 21 is in the outward folded status (as shown in FIG. 2C), the image presenting direction of the image in the vision region 211 is changed (for example, upside down) to facilitate users located at two sides of the display device 20 to view the images presented in the vision regions 211 and 212 respectively.

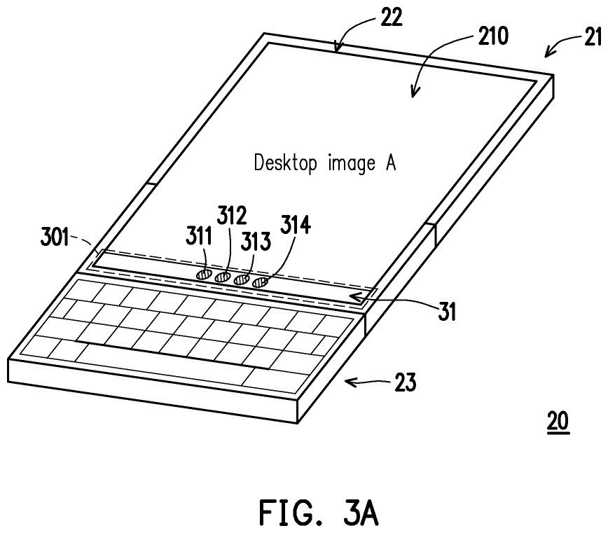

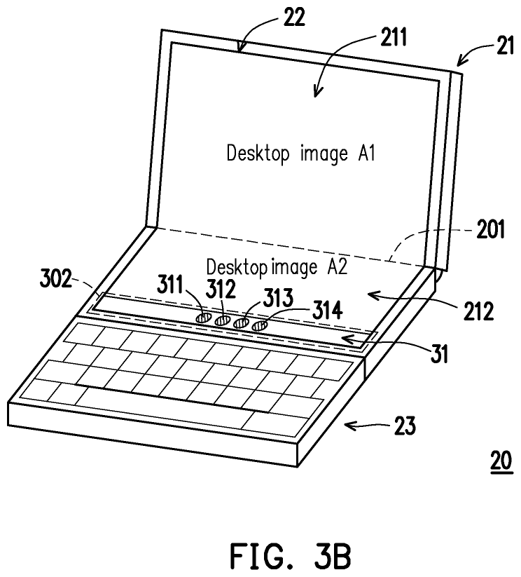

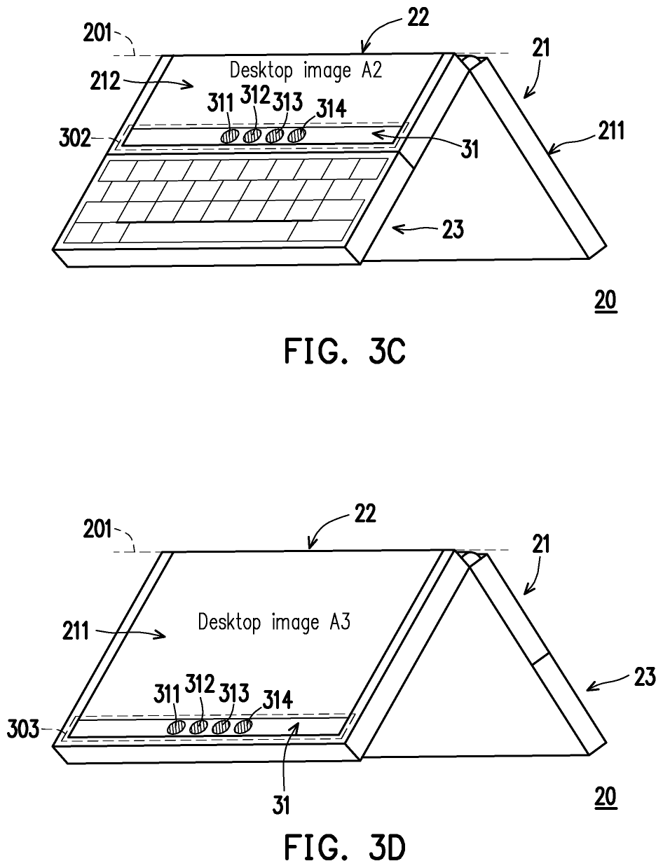

FIG. 3A is a schematic diagram of an original desktop image and a toolbar image shown according to an embodiment of the invention. Referring to FIG. 3A, in an embodiment, when the physical status of the foldable display 21 is the unfolded status, a desktop image A (i.e., the original desktop image) may be presented in the vision region 210 (i.e., the original vision region). At the same time, the toolbar image 31 may be presented at a position 301 in the vision region 210. For example, virtual buttons 311 to 314 may be presented in the toolbar image 31. The virtual buttons 311 to 314 are respectively configured to launch corresponding applications (i.e., target applications).

FIG. 3B to FIG. 3D are schematic diagrams of a first desktop image, a second desktop image, and a toolbar image shown according to an embodiment of the invention. Referring to FIG. 3B, in an embodiment, at a certain point in time, when the physical status of the foldable display 21 is an inward folded status, a desktop image A1 (i.e., the first desktop image) and a desktop image A2 (i.e., the second desktop image) may be respectively presented in the vision region 211 (i.e., the first sub-vision region) and the vision region 212 (i.e., the second sub-vision region). At the same time, the toolbar image 31 may be presented at a position 302 in the vision region 212.

Please refer to FIG. 3C and FIG. 3D. In an embodiment, at another point in time, when the physical status of the foldable display 21 is the outward folded status, a desktop image A3 (i.e., the first desktop image) and the desktop image A2 may be presented in the vision regions 211 and 212 respectively. It should be noted that the image presenting direction of the desktop image A3 in FIG. 3D may be opposite to the image presenting direction of the desktop image A1 in FIG. 3B (for example, upside down). At the same time, the toolbar image 31 may be presented at the position 302 in the vision region 212 or a position 303 in the vision region 211. Alternatively, in an embodiment, the toolbar image 31 may also be presented at the positions 302 and 303 at the same time, which is not limited by the invention. In an embodiment, one of the positions 301 to 303 may be the first position, and the other one of the positions 301 to 303 may be the second position.

It should be noted that, the presenting position of the toolbar image 31 in FIG. 3A to FIG. 3D may be adjusted according to the toolbar configuration information and practical needs, such as moving up or down, or may be disposed at the left side or right side of any vision region, etc. instead, which is not limited by the invention. Moreover, the configuration of the virtual buttons 311 to 314 in the toolbar image 31 may also be adjusted according to practical needs, and more useful information (such as the power information or network connection information of the display device 10 of FIG. 1) may also be presented in the toolbar image 31, which is not limited by the invention.

Returning to FIG. 1, in an embodiment, when the physical status of the foldable display 11 is the unfolded status, the processor 14 may present the target image in the original vision region via the application programming interface 102. For example, the target image may include an application image. Compared with the desktop image, this application image may present the execution screen of the application currently running in the foreground by the processor 14.

In an embodiment, in response to the physical status of the foldable display 11 being the folded status, the processor 14 may completely present the target image in a certain sub-vision region (such as the first sub-vision region or the second sub-vision region) via the application programming interface 102. In an embodiment, in response to the physical status of the foldable display 11 being the folded status, the processor 14 may also dynamically adjust the display parameters (such as resolution) of the target image to meet the display requirement of completely presenting the target image in the first sub-vision region or the second sub-vision region.

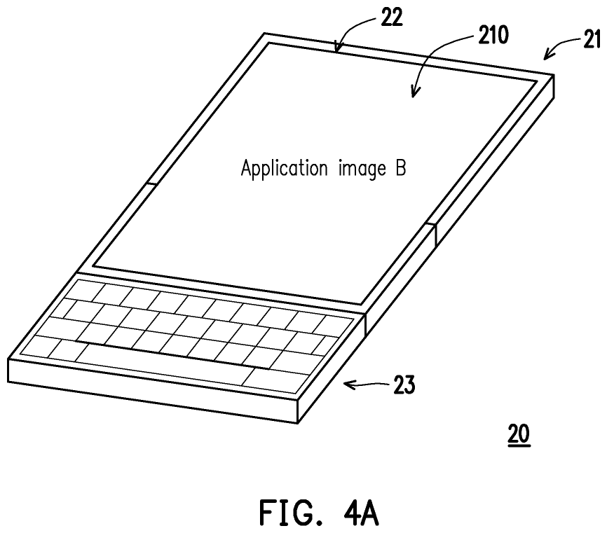

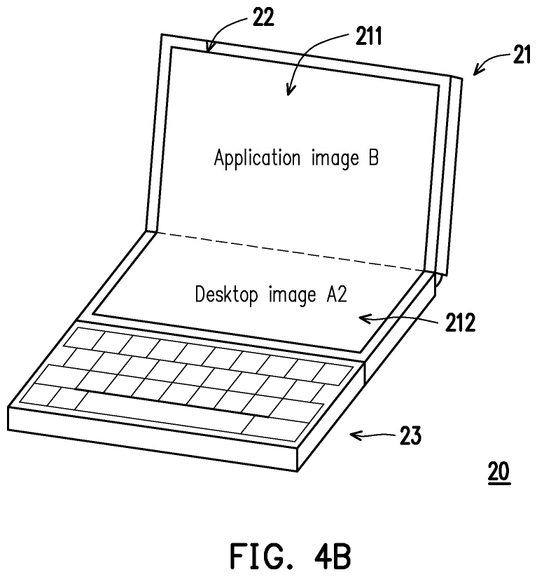

FIG. 4A is a schematic diagram of presenting an application image in an original vision region shown according to an embodiment of the invention. Referring to FIG. 4A, in an embodiment, when the physical status of the foldable display 21 is the unfolded status, the application image B may be presented in the vision region 210 (i.e., the original vision region). For example, the application image B may be completely presented in the vision region 210.

FIG. 4B is a schematic diagram of presenting an application image in a sub-vision region shown according to an embodiment of the invention. Referring to FIG. 4B, in an embodiment, when the physical status of the foldable display 21 is the folded status, the application image B may be switched to be presented in the vision region 211 (i.e., the first sub-vision region).

In an embodiment, according to the size and/or resolution of the vision region 211, the display parameters (e.g., resolution) of the application image B may be dynamically adjusted to meet the display requirements for fully presenting the application image B in the vision region 211. In addition, while the application image B is presented in the vision region 211, the desktop image A2 (i.e., the second desktop image) or other application images may be presented in the vision region 212 (i.e., the second sub-vision region).

It should be noted that, in another embodiment of FIG. 4B, when the physical status of the foldable display 11 is the folded status, the application image B may also be switched to be presented in the vision region 212 (i.e., the second sub-vision region). At the same time, the display parameters (e.g., resolution) of the application image B may be dynamically adjusted according to the size and/or resolution of the vision region 212.

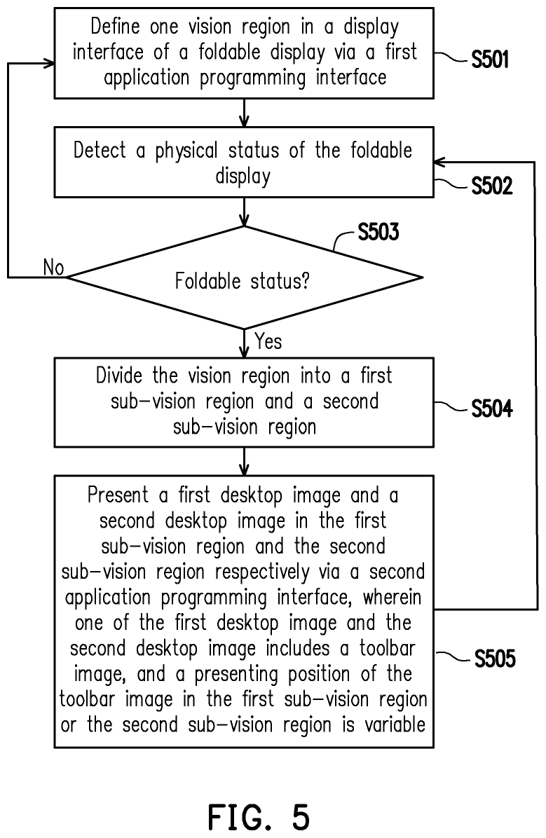

FIG. 5 is a flowchart of an image presenting method shown according to an embodiment of the invention. Referring to FIG. 5, in step S501, one vision region is defined in a display interface of a foldable display via a first application programming interface. In step S502, a physical status of the foldable display is detected. In step S503, whether the physical status of the foldable display is a folded status is determined. If the physical status of the foldable display is the folded status, in step S504, the vision region is divided into a first sub-vision region and a second sub-vision region. In step S505, a first desktop image and a second desktop image are presented respectively in the first sub-vision region and the second sub-vision region via a second application programming interface. It should be noted that, one of the first desktop image and the second desktop image includes a toolbar image, and a presenting position of the toolbar image in the first sub-vision region or the second sub-vision region is variable. However, if the determination in step S503 is no, then the process may return to step S501. In addition, after step S505, step S502 may be executed again.

However, each step in FIG. 5 is as described in detail above, and is not repeated herein. It should be mentioned that, each step in FIG. 5 may be implemented as a plurality of program codes or circuits, and the invention is not limited thereto. Moreover, the method of FIG. 5 may be used with the above exemplary embodiments, and may also be used alone, and the invention is not limited thereto.

Based on the above, by running the first application programming interface (such as OpenXR API) and the second application programming interface (such as Intel Display Pipes MPO API), the image presenting method and the display device proposed by the invention may define one or a plurality of vision regions (such as the original vision region and the plurality of sub-vision regions) in the display interface of the foldable display and customize the images presented in the vision regions to improve system operational flexibility. In addition, via the toolbar configuration information that may be dynamically updated, the toolbar image may also be presented at any position in any vision region according to the user's needs, thereby effectively improving the user experience.

Although the invention has been described with reference to the above embodiments, it will be apparent to one of ordinary skill in the art that modifications to the described embodiments may be made without departing from the spirit of the disclosure. Accordingly, the scope of the disclosure is defined by the attached claims not by the above detailed descriptions.

What is claimed is:

1. An image presenting method, configured for a display device, wherein the display device comprises a foldable display, and the image presenting method comprises:
defining one vision region in a display interface of the foldable display via a first application programming interface;
detecting a physical status of the foldable display;
dividing the vision region into a first sub-vision region and a second sub-vision region in response to the physical status of the foldable display being a folded status; and
presenting a first desktop image and a second desktop image respectively in the first sub-vision region and the second sub-vision region via a second application programming interface,
wherein one of the first desktop image and the second desktop image comprises a toolbar image, and a presenting position of the toolbar image in the first sub-vision region or the second sub-vision region is variable.

2. The image presenting image of claim 1, wherein the step of presenting the first desktop image and the second desktop image respectively in the first sub-vision region and the second sub-vision region via the second application programming interface comprises:
obtaining toolbar configuration information; and
presenting the toolbar image in the first sub-vision region or the second sub-vision region according to the toolbar configuration information.

3. The image presenting method of claim 2, further comprising:
receiving a user operation; and
updating the toolbar configuration information according to the user operation to adjust the presenting position of the toolbar image in the first sub-vision region or the second sub-vision region.

4. The image presenting method of claim 1, further comprising:
presenting at least one virtual button in the toolbar image, wherein each virtual button is configured to launch a target application.

5. The image presenting method of claim 1, further comprising:
presenting a target image in the vision region via the second application programming interface when the physical status of the foldable display is an unfolded status; and
presenting the target image completely in the first sub-vision region or the second sub-vision region via the second application programming interface in response to the physical status of the foldable display being the folded status.

6. A display device, comprising:
a foldable display; and
a processor coupled to the foldable display,
wherein the processor is configured to:
define one vision region in a display interface of the foldable display via a first application programming interface;
detect a physical status of the foldable display;
divide the vision region into a first sub-vision region and a second sub-vision region in response to the physical status of the foldable display being a folded status; and
present a first desktop image and a second desktop image respectively in the first sub-vision region and the second sub-vision region via a second application programming interface,
wherein one of the first desktop image and the second desktop image comprises a toolbar image, and a presenting position of the toolbar image in the first sub-vision region or the second sub-vision region is variable.

7. The display device of claim 6, wherein the operation of the processor presenting the first desktop image and the second desktop image respectively in the first sub-vision region and the second sub-vision region via the second application programming interface comprises:
obtaining toolbar configuration information; and
presenting the toolbar image in the first sub-vision region or the second sub-vision region according to the toolbar configuration information.

8. The display device of claim 7, wherein the processor is further configured to:
receive a user operation; and
update the toolbar configuration information according to the user operation to adjust the presenting position of the toolbar image in the first sub-vision region or the second sub-vision region.

9. The display device of claim 6, wherein the processor is further configured to:
present at least one virtual button in the toolbar image, wherein each virtual button is configured to launch a target application.

10. The display device of claim 6, wherein the processor is further configured to:
present a target image in the vision region via the second application programming interface when the physical status of the foldable display is an unfolded status; and
present the target image completely in the first sub-vision region or the second sub-vision region via the second application programming interface in response to the physical status of the foldable display being the folded status.
